(19) United States
(12) Patent Application Publication
(10) Pub. No.: US 2018/0126838 A1
(43) Pub. Date: May 10, 2018

(54) DRIVE DEVICE FOR VEHICLE

(71) Applicant: TOYOTA JIDOSHA KABUSHIKI KAISHA, Toyota-shi (JP)

(72) Inventors: Tomoaki YANAGIDA, Susono-shi (JP); Yoshio ITO, Susono-shi (JP)

(73) Assignee: TOYOTA JIDOSHA KABUSHIKI KAISHA, Toyota-shi (JP)

(21) Appl. No.: 15/800,645

(22) Filed: Nov. 1, 2017

(30) Foreign Application Priority Data
Nov. 7, 2016 (JP) 2016-217436

(51) Int. Cl. B60K 6/48; B60K 6/387

(52) U.S. Cl. CPC B60K 6/48; B60K 6/387; Y10S 903/914; B60Y 2200/92; B60Y 2306/03; B60K 2006/4825

(57) ABSTRACT

A drive device for a vehicle includes a power transmission mechanism configured to transmit power output from an output shaft of an engine mounted in the vehicle to wheels of the vehicle, an auxiliary device, a layshaft disposed on a different axis from the output shaft, and a switching clutch configured to selectively connect one of a first shaft and a second shaft to a third shaft so as to transmit power. The layshaft includes the first shaft, the second shaft, and the third shaft. The first shaft is coupled to the output shaft so as to transmit power. The second shaft is coupled to axles attached to the wheels so as to transmit power. The third shaft is configured to relatively rotate with respect to the first shaft and the second shaft, and is coupled to the auxiliary device so as to transmit power.

### INCORPORATION BY REFERENCE

The disclosure of Japanese Patent Application No. 2016-217436 filed on Nov. 7, 2016 including the specification, drawings and abstract is incorporated herein by reference in its entirety.

### BACKGROUND

### 1. Technical Field

The present disclosure relates to a drive device for a vehicle.

### 2. Description of Related Art

Japanese Unexamined Patent Application Publication No. 2011-231844 (JP 2011-231844 A) discloses a configuration in which, as an auxiliary device drive mechanism that transmits power to an auxiliary device, such as an oil pump or an alternator, two clutches are provided to selectively switch a connection destination of the auxiliary device to one of an engine and wheels (see FIG. 4 of JP 2011-231844 A). In this configuration, the two clutches are engaged and released, whereby it is possible to switch between a case where the auxiliary device is driven by the engine and a case where the auxiliary device is driven with power transmitted from the wheels.

### SUMMARY

However, in the configuration disclosed in FIG. 4 of JP 2011-231844 A, the operations of the two clutches should be controlled in a case of switching the connection destination of the auxiliary device. In this case, at the time of switching of the connection destination, a timing at which a first clutch is released should match a timing at which a second clutch is engaged. In this way, there is a need for complicated and high-accuracy control for the two clutches as a control target.

The present disclosure provides a drive device for a vehicle capable of, in a case of switching a connection destination of an auxiliary device between an engine side and a wheel side, switching the connection destination with simple control.

An aspect of the present disclosure relates to a drive device for a vehicle including a power transmission mechanism, an auxiliary device, a layshaft, and a switching clutch. The power transmission mechanism is configured to transmit power output from an output shaft of an engine mounted in the vehicle to wheels of the vehicle. The layshaft is disposed on a different axis from the output shaft. The switching clutch is configured to selectively connect one of a first shaft and a second shaft to a third shaft so as to transmit power. The layshaft includes the first shaft, the second shaft, and the third shaft. The first shaft is coupled to the output shaft so as to transmit power. The second shaft is coupled to axles attached to the wheels so as to transmit power. The third shaft is configured to relatively rotate with respect to the first shaft and the second shaft, and is coupled to the auxiliary device so as to transmit power.

According to the aspect of the present disclosure, it is possible to switch the connection destination of the auxiliary device between the engine and the wheels with the single switching clutch. With this, in a case of switching the connection destination of the auxiliary device, since it is possible to switch the connection destination by operating the single switching clutch, a structure or switching control is simplified. In addition, since a single clutch for switching the connection destination of the auxiliary device may be provided, reduction in size and weight of the drive device is achieved. The switching clutch is configured to selectively connect one of the first shaft and the second shaft to the third shaft such that power transmission is possible, that is, has a structure in which the second shaft is not connectable to the third shaft in a state in which the first shaft is connected to the third shaft. That is, the first shaft and the second shaft are not connected to each other in a case of driving the auxiliary device due to the structure of the switching clutch. For this reason, it is possible to realize simple control compared to switching control in a configuration in which two clutches that are connectable the first shaft and the second shaft are provided as in the related art.

In the drive device according to the aspect of the present disclosure, the first shaft, the second shaft, the third shaft, and the switching clutch may be disposed on the same axis. One of the first shaft and the second shaft may be a hollow shaft. The third shaft may be disposed to pass through the inside of the hollow shaft.

According to the aspect of the present disclosure, since the third shaft is disposed to pass through the inside of the first shaft or the second shaft constituted of the hollow shaft, it is possible to suppress an increase in length of an auxiliary device drive mechanism in an axial direction. With this, reduction in size and weight of the drive device is achieved.

In the drive device according to the aspect of the present disclosure, the auxiliary device may include a mechanical oil pump configured to be driven with rotation of the third shaft and supply lubricant oil to a part to be lubricated of the vehicle. The switching clutch may be a meshing type clutch. The switching clutch may be configured to connect the first shaft and the third shaft such that power transmission is possible when an ignition switch of the vehicle is turned off, and shut off between the second shaft and the third shaft such that power transmission is impossible.

According to the aspect of the present disclosure, the mechanical oil pump and the engine are connected such that power transmission is possible in a state in which the ignition switch of the vehicle is turned off. For this reason, in a case where the engine is started, it is possible to readily drive the mechanical oil pump with the engine, and to supply lubricant oil to the part to be lubricated of the vehicle. Furthermore, since the switching clutch is constituted of the meshing type clutch, a clutch structure is simplified and reduced in size, and mountability of the clutch is improved. With this, reduction in size and weight of the drive device is achieved.

In the drive device according to the aspect of the present disclosure, the power transmission mechanism may include a disconnection clutch configured to selectively disconnect the engine from the wheels during traveling. The auxiliary device may include a mechanical oil pump configured to be driven with rotation of the third shaft and supply lubricant oil to a part to be lubricated of the vehicle. The switching clutch may be a meshing type clutch. The switching clutch may be configured to connect the second shaft and the third shaft such that power transmission is possible in a vehicle state in which fuel supply to the engine and ignition are stopped during traveling of the vehicle and the disconnection clutch is released to disconnect the engine from the wheels, and shut off between the first shaft and the third shaft such that power transmission is impossible.

According to the aspect of the present disclosure, in the vehicle state in which fuel supply to the engine and ignition are stopped during traveling and the engine and the wheels are disconnected, the mechanical oil pump and the axles are connected by the switching clutch such that power transmission is possible. For this reason, it is possible to drive the mechanical oil pump with power of the wheels, and to supply lubricant oil to the part to be lubricated of the vehicle.

In the drive device according to the aspect of the present disclosure, the auxiliary device may include a motor generator configured to be coupled to the mechanical oil pump such that power transmission is possible and operate as a power generator and an electric motor. The motor generator may be configured to operate as an electric motor that outputs power transmitted to the wheels or operate as a power generator with rotation force input from the wheels to the axles when the meshing type clutch connects the second shaft and the third shaft such that power transmission is possible in a vehicle state in which fuel supply to the engine and ignition are stopped during traveling of the vehicle and the disconnection clutch is released to disconnect the engine from the wheels.

According to the aspect of the present disclosure, in a state in which the engine is selectively disconnected from the wheels, the motor generator and the wheels are connected by the switching clutch such that power transmission is possible. For this reason, it is possible to perform traveling with power output from the motor generator, and to perform regenerative electric power generation with power of the wheels using the motor generator. At this time, since the engine is disconnected from the wheels, it is possible to prevent the power of the engine from being used to rotate the engine, and to reduce energy loss. When the switching clutch connects the auxiliary device and the wheels such that power transmission is possible, the motor generator can operate as an electric motor or a power generator for regenerative electric power generation. When the switching clutch connects the auxiliary device and the engine such that power transmission is possible, the motor generator can operate as a power generator or a start device of the engine.

In the drive device according to the aspect of the present disclosure, the switching clutch may be configured to be switched to a neutral state in which the first shaft and the second shaft are shut off from the third shaft such that power transmission is impossible. The auxiliary device may include a mechanical oil pump configured to be driven with rotation of the third shaft and supply lubricant oil to a part to be lubricated of the vehicle. The auxiliary device may include a motor generator configured to be coupled to the mechanical oil pump such that power transmission is possible and operate as an electric motor and a power generator. The motor generator may be configured to operate as an electric motor that drives the mechanical oil pump when the switching clutch is in the neutral state.

According to the aspect of the present disclosure, it is possible to switch among three states including a state, in which the auxiliary device and the engine are connected such that power transmission is possible, a state, in which the auxiliary device and the wheels are connected such that power transmission is possible, and the neutral state, in which the auxiliary device is disconnected from the engine and the wheels, by the single switching clutch. When the switching clutch is in the neutral state, it is possible to drive the mechanical oil pump by the motor generator to supply lubricant oil to the part to be lubricated of the vehicle.

According to the aspect of the present disclosure, in a case of switching the connection destination of the auxiliary device between the engine side and the wheel side, since the single switching clutch may be operated, it is possible to switch the connection destination with simple control.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic view showing a drive device for a vehicle in an embodiment;

FIG. 2 is a diagram illustrating a state in which an auxiliary device is connected to an engine shaft;

FIG. 3 is a diagram illustrating a case where wheels are driven by an engine in a state in which the auxiliary device is connected to axles;

FIG. 4 is a diagram illustrating a case where the engine is stopped in a state in which the auxiliary device is connected to the axles;

FIG. 5 is a diagram illustrating a state in which the auxiliary device is not connected to the engine shaft and the axles;

FIG. 6 is a schematic view showing a drive device for a vehicle in a modification example; and

FIG. 7 is a diagram showing an example of a frictional switching clutch.

### DETAILED DESCRIPTION OF EMBODIMENTS

Hereinafter, a drive device for a vehicle in an embodiment of the present disclosure will be specifically described referring to the drawings.

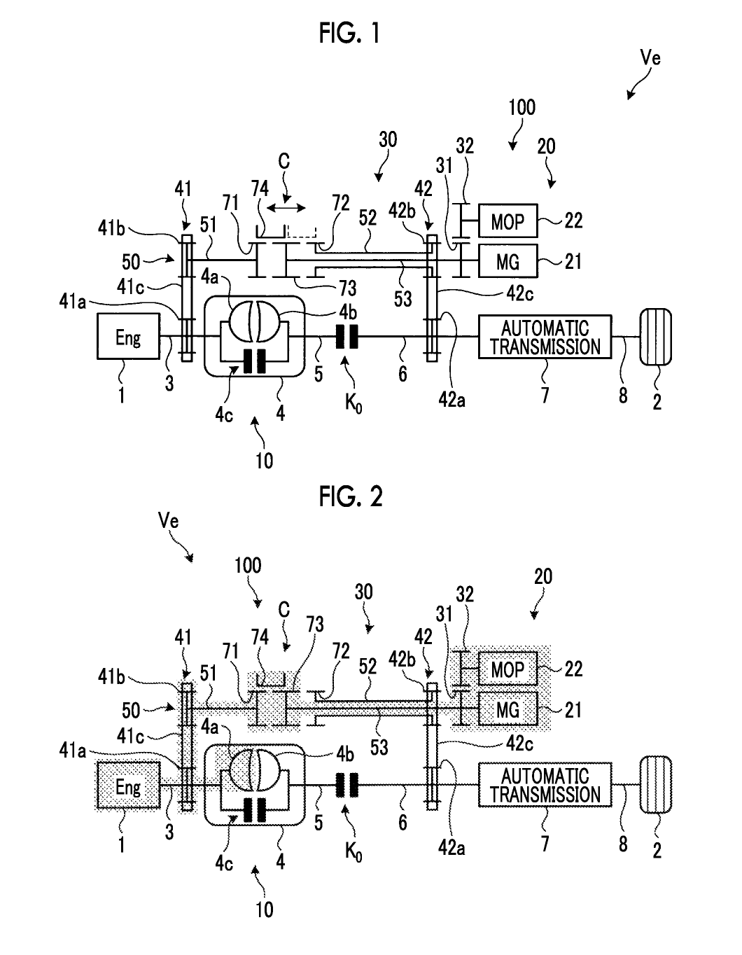

FIG. 1 is a schematic view showing the drive device for a vehicle in the embodiment. As shown in FIG. 1, a drive device 100 is mounted in a vehicle Ve, and includes an engine (Eng) 1 as a power source for traveling. The engine 1 is constituted of a known internal combustion engine. The drive device 100 includes a power transmission mechanism 10 that transmits power output from the engine 1 to wheels 2, and an auxiliary device drive mechanism 30 that transmits power to an auxiliary device 20.

The power transmission mechanism 10 constitutes a power transmission path between the engine 1 and the wheels 2. The power transmission mechanism 10 includes an output shaft (hereinafter, referred to as an “engine shaft”) 3 of the engine 1, a torque converter 4, a turbine shaft 5, an engine disconnection clutch K0 (hereinafter, simply referred to as a “clutch K0”), an input shaft 6, an automatic transmission 7, and axles 8.

The torque converter 4 includes a pump impeller 4a that rotates integrally with the engine shaft 3, a turbine runner 4b disposed to face the pump impeller 4a, and a lockup clutch (hereinafter, referred to as an “L/U clutch”) 4c. The turbine shaft 5 is coupled to the turbine runner 4b so as to rotate integrally with the turbine runner 4b. The turbine shaft 5 is an output shaft of the torque converter 4.

Oil (hydraulic pressure) is supplied from a hydraulic circuit (not shown) into the torque converter 4. The L/U clutch 4c is switched between an engagement state and a release state by the hydraulic pressure supplied from the hydraulic circuit. In a case where the L/U clutch 4c is engaged, the engine 1 is coupled directly to the turbine shaft 5. In a case where the L/U clutch 4c is released, power of the engine 1 is transmitted to the turbine runner 4b through oil inside the torque converter 4. Inside the torque converter 4, a stator is disposed between the pump impeller 4a and the turbine runner 4b. The stator is held by a case through a one-way clutch (both are not shown).

The clutch K0 is a clutch that is provided to disconnect the engine 1 from the wheels 2. The clutch K0 is configured to be selectively switchable between an engagement state in which the engine 1 and the wheels 2 are connected such that power transmission is possible, and a release state in which the engine 1 and the wheels 2 are shut off such that power transmission is impossible. In the example shown in FIG. 1, the clutch K0 is provided between the torque converter 4 and the automatic transmission 7 in the power transmission path from the engine 1 to the wheels 2. The clutch K0 includes an input side engagement element that rotates integrally with the turbine shaft 5, and an output side engagement element that rotates integrally with the input shaft 6. For example, the clutch K0 is constituted of a hydraulic frictional clutch. In this case, the clutch K0 includes a hydraulic actuator (not shown), and is configured such that the input side engagement element and the output side engagement element are frictionally engaged when hydraulic pressure is supplied from the hydraulic circuit to the hydraulic actuator.

The input shaft 6 is a member that inputs power output from the engine 1 to the automatic transmission 7. In the example shown in FIG. 1, the clutch K0 is provided between the turbine shaft 5 and the input shaft 6 in the power transmission path. That is, the engine 1 is coupled to the automatic transmission 7 through the clutch K0.

The automatic transmission 7 is constituted of a known automatic transmission. For example, the automatic transmission 7 has a planetary gear mechanism and an engagement device, and is configured to set a plurality of gear ratios by switching the engagement device between an engagement state and a release state. The automatic transmission 7 shown in FIG. 1 includes a differential gear mechanism coupled to the right and left axles 8. The axles 8 are attached to the wheels 2 and rotate integrally with the wheels 2.

The drive device 100 is configured to be switchable between a case where the auxiliary device 20 is driven by the engine 1 and a case where the auxiliary device 20 is driven with power transmitted from the wheels 2. As shown in FIG. 1, the auxiliary device drive mechanism 30 includes a first power transmission device 41 that couples the power transmission mechanism 10 and the auxiliary device 20 on the engine 1 side such that power transmission is possible, and a second power transmission device 42 that couples the power transmission mechanism 10 and the auxiliary device 20 on the wheels 2 side such that power transmission is possible. The auxiliary device drive mechanism 30 includes a single switching clutch C configured to selectively switch a connection destination of the auxiliary device 20 to one of the engine 1 and the wheels 2. The engine 1 side and the wheels 2 side represent the engine 1 side and the wheels 2 side based on the clutch K0 in the power transmission path from the engine 1 to the wheels 2.

In detail, the auxiliary device 20 includes a motor generator (MG) 21 that operates as an electric motor and a power generator, and a mechanical oil pump (MOP) 22. The motor generator 21 and the mechanical oil pump 22 are connected such that power transmission is possible. In a case of operating as an electric motor, the motor generator 21 operates as a device (start device) that starts the engine 1 or a device that drives the mechanical oil pump 22. The mechanical oil pump 22 is an oil supply source that supplies lubricant oil to a part (gear or the like) to be lubricated included in the drive device 100. In the example shown in FIG. 1, a drive gear 31 provided on a rotational shaft (rotor shaft) of the motor generator 21 meshes with a driven gear 32 provided on a rotational shaft (pump shaft) of the mechanical oil pump 22. The rotor shaft of the motor generator 21 is disposed on the same axis as a layshaft 50.

The auxiliary device drive mechanism 30 has the layshaft 50 that is disposed on a different axis from the engine shaft 3. The layshaft 50 includes a first shaft 51 coupled to the engine shaft 3 (engine 1) through the first power transmission device 41 such that power transmission is possible, a second shaft 52 coupled to the axles 8 (wheels 2) through the second power transmission device 42 such that power transmission is possible, and a third shaft 53 that is a drive shaft of the auxiliary device 20. The third shaft 53 is a rotational shaft that is relatively rotatable with respect to the first shaft 51 and the second shaft 52.

As shown in FIG. 1, all of the first shaft 51, the second shaft 52, and the third shaft 53 are disposed on the same axis. The first shaft 51 is disposed in parallel with the engine shaft 3. The second shaft 52 is constituted of a hollow shaft, and is disposed in parallel with the input shaft 6. The third shaft 53 is disposed to pass through the inside of the second shaft 52, and both end portions thereof protrude from both end portions of the second shaft 52. The third shaft 53 is a rotor shaft of the motor generator 21, and is provided with the drive gear 31.

The first power transmission device 41 is a mechanism that couples the first shaft 51 and the engine shaft 3 such that power transmission is possible. For example, the first power transmission device 41 is constituted of a known power transmission device, such as a chain type, a belt type, or a gear pair. The first power transmission device 41 shown in FIG. 1 is of a chain type, and has a first gear 41a provided on the engine shaft 3, a second gear 41b provided on the first shaft 51, and a chain 41c wound around the first gear 41a and the second gear 41b. A gear ratio of the first power transmission device 41, that is, the ratio of a rotation speed of the engine shaft 3 to a rotation speed of the first shaft 51 may be set to an arbitrary value.

The second power transmission device 42 is a mechanism that couples the second shaft 52 and the wheels 2 such that power transmission is possible. For example, the second power transmission device 42 is constituted of a known power transmission device, such as a chain type, a belt type, or a gear pair. The second power transmission device 42 shown in FIG. 1 is of a chain type, and has a first gear 42a provided on the input shaft 6, a second gear 42b provided on the second shaft 52, and a chain 42c wound around the first gear 42a and the second gear 42b. A gear ratio of the second power transmission device 42, that is, a ratio of a rotation speed of the input shaft 6 to a rotation speed of the second shaft 52 may be set to an arbitrary value. The relationship between the gear ratio of the second power transmission device 42 and the gear ratio of the first power transmission device 41 may be set to an arbitrary relationship.

The switching clutch C is constituted of a meshing type clutch provided on the same axis as the layshaft 50. The switching clutch C is configured to selectively connect one of the first shaft 51 and the second shaft 52 to the third shaft 53. Specifically, the switching clutch C can be switched among a first engagement state in which the first shaft 51 and the third shaft 53 are connected such that power transmission is possible, a second engagement state in which the second shaft 52 and the third shaft 53 are connected such that power transmission is possible, and a neutral state in which the first shaft 51 and the second shaft 52 are shut off from the third shaft 53 such that power transmission is impossible.

As shown in FIG. 1, the switching clutch C includes a meshing type first engagement element 71 that rotates integrally with the first shaft 51, a meshing type second engagement element 72 that rotates integrally with the second shaft 52, a clutch hub 73 that is coupled to the third shaft 53 so as to rotate integrally with the third shaft 53, a sleeve 74 that is movable in an axial direction, and the like. Spline teeth (dog teeth) are formed on the outer circumferential surfaces of the first engagement element 71, the second engagement element 72, and the clutch hub 73. Spline teeth are formed on the inner circumferential surface of the sleeve 74. The sleeve 74 moves in the axial direction while being spline-fitted to the clutch hub 73. For example, the switching clutch C is of a hydraulic type, and the sleeve 74 moves in the axial direction by the hydraulic actuator. In this case, the switching clutch C is provided with an elastic member (return spring) that applies a load to move the sleeve 74 to the first engagement element 71 side in the axial direction.

As indicated by a solid line in FIG. 1, the sleeve 74 is positioned on the first engagement element 71 side, and the spline teeth of the sleeve 74 mesh with the spline teeth of the first engagement element 71, whereby the switching clutch C is brought into the first engagement state. In the first engagement state, the engine 1 and the auxiliary device 20 (that constitute a first path) are connected such that power transmission is possible. The spline teeth of the sleeve 74 do not mesh with the spline teeth of the second engagement element 72. For this reason, in the first engagement state, the wheels 2 and the auxiliary device 20 (that constitute a second path) are shut off such that power transmission is impossible.

As indicated by a broken line in FIG. 1, the sleeve 74 is positioned on the second engagement element 72 side, and the spline teeth of the sleeve 74 mesh with the spline teeth of the second engagement element 72, whereby the switching clutch C is brought into the second engagement state. In the second engagement state, the wheels 2 and the auxiliary device 20 (that constitute the second path) are connected such that power transmission is possible. The spline teeth of the sleeve 74 do not mesh with the spline teeth of the first engagement element 71. For this reason, in the second engagement state, the engine 1 and the auxiliary device 20 (that constitute the first path) are shut off such that power transmission is impossible.

The spline teeth of the sleeve 74 do not mesh with both of the spline teeth of the first engagement element 71 and the spline teeth of the second engagement element 72, whereby the switching clutch C is brought into the neutral state. In the neutral state, the engine 1 and the auxiliary device 20 (that constitute the first path) and the wheels 2 and the auxiliary device 20 (that constitute the second path) are shut off such that power transmission is impossible.

The switching clutch C has a structure in which the first shaft 51 and the second shaft 52 are not engaged. For this reason, in the auxiliary device drive mechanism 30, the first shaft 51 and the second shaft 52 are not connected through the switching clutch C such that power transmission is possible. That is, the drive device 100 has a structure in which power output from the engine 1 is not transmittable to the wheels 2 through the auxiliary device drive mechanism 30. With this, it is possible to prevent connection of the engine shaft 3 and the axles 8 on the layshaft 50 side.

The switching clutch C is controlled to one of the first engagement state, the second engagement state, and the neutral state according to a vehicle state. Since the drive device 100 has the clutch K0, the drive device 100 can release the clutch K0 during traveling according to the vehicle state. For example, the drive device 100 can make the vehicle Ve coast (travel freely) in a traveling state in which fuel supply to the engine 1 and ignition are stopped (fuel cut) during forward traveling of the vehicle Ve, and the clutch K0 is released to disconnect the engine 1 from the wheels 2. That is, the vehicle Ve is a vehicle in which the engine 1 can be automatically stopped and restarted. As an example of an execution condition of free traveling, a case where an accelerator pedal and a brake pedal are not depressed in a traveling state in which a vehicle speed is higher than a predetermined vehicle speed is exemplified.

FIG. 2 is a diagram illustrating a state in which the auxiliary device 20 is connected to the engine shaft 3. As shown in FIG. 2, in a case where the switching clutch C is in the first engagement state, the auxiliary device 20 is connected to the engine 1 such that power transmission is possible. A dot-patterned part shown in FIG. 2 represents a part that rotates in synchronization with the third shaft 53 in a case where the drive shaft (third shaft 53) of the auxiliary device 20 rotates in the first engagement state.

Then, the switching clutch C is controlled to the first engagement state according to the vehicle state. In this case, the operation and the state of the switching clutch C are controlled by an electronic control unit (ECU) (not shown). For example, when an ignition switch of the vehicle Ve is turned off (first vehicle state: during ignition OFF), the switching clutch C is brought into the first engagement state, and the auxiliary device 20 is connected to the engine shaft 3 such that power transmission is possible. That is, an initial state of the switching clutch C is the first engagement state. Then, an initial position of the sleeve 74 is a position where the sleeve 74 is engaged with the first engagement element 71 and the clutch hub 73. As another example of a vehicle state in which the switching clutch C is brought into the first engagement state, a case (second vehicle state: during idle reduction) where the engine 1 rotates at an idle rotation speed and the vehicle Ve is stopped, or a case (third vehicle state: during lockup OFF and engine traveling) where the L/U clutch 4c of the torque converter 4 is released and the vehicle Ve is traveling with the power of the engine 1 is exemplified.

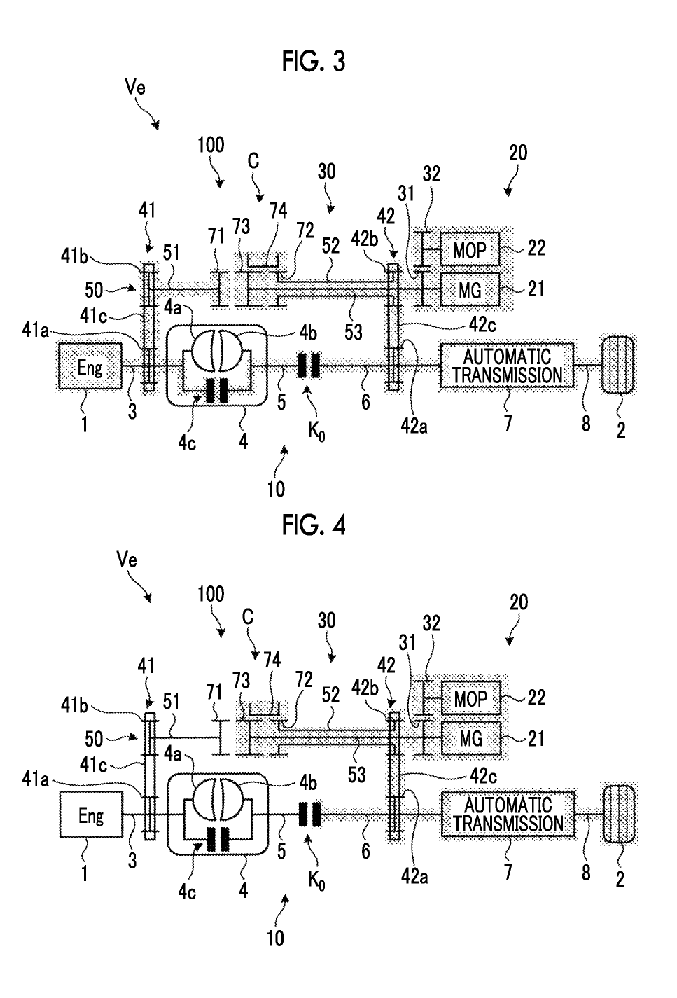

A state in which the auxiliary device 20 is connected to the axles 8 (second engagement state) will be described referring to the FIGS. 3 and 4. FIG. 3 is a diagram illustrating a case where the engine 1 is driven in a state in which the auxiliary device 20 is connected to the axles 8. FIG. 4 is a diagram illustrating a case where the engine 1 is stopped in a state where the auxiliary device 20 is connected to the axles 8. A dot-patterned part shown in FIG. 3 represents a part that rotates in synchronization with the third shaft 53 in a case where the third shaft 53 rotates with the engine 1 being driven in the second engagement state. A dot-patterned part shown in FIG. 4 represents a part that rotates in synchronization with the third shaft 53 in a case where the third shaft 53 rotates with the engine 1 being stopped in the second engagement state.

As shown in FIG. 3, in a case where the switching clutch C is in the second engagement state, the auxiliary device 20 and the wheels 2 are connected such that power transmission is possible. In this state, in a case where the clutch K0 is engaged to drive the engine 1, power transmitted from the engine 1 to the input shaft 6 is transmitted to the second shaft 52 through the second power transmission device 42. That is, the auxiliary device 20 is driven by the engine 1. For example, in a case (fourth vehicle state: during lockup ON and engine traveling) where traveling is performed with the power of the engine 1 in a state in which the L/U clutch 4c of the torque converter 4 is engaged and the clutch K0 is engaged, the switching clutch C is brought into the second engagement state.

The vehicle state shown in FIG. 4 is different from the vehicle state shown in FIG. 3, and is a vehicle state in which the engine 1 is stopped and the clutch K0 is released to disconnect the engine 1 from the wheels 2. That is, as a case where the switching clutch C is brought into the second engagement state, a vehicle state in which the vehicle Ve is traveling in a state in which the engine 1 is stopped and the engine 1 is disconnected from the wheels 2 is exemplified.

In more detail, as the vehicle state shown in FIG. 4, a case (fifth vehicle state: during EV traveling) where traveling is performed with the motor generator 21 being operated as an electric motor, a case (sixth vehicle state: during free traveling) where fuel supply to the engine 1 and ignition are stopped during traveling and the clutch K0 is released to perform coasting, or a case (seventh vehicle state: during MG regeneration) where regenerative electric power generation is performed with external force (rotation force) input from the wheels 2 to the axles 8 during deceleration using the motor generator 21 is exemplified.

During the EV traveling, power output from the motor generator 21 is transmitted from the third shaft 53 to the second shaft 52 through the switching clutch C, and is transmitted from the second shaft 52 to the input shaft 6 through the second power transmission device 42. The mechanical oil pump 22 is driven by the motor generator 21.

Since the clutch K0 is released, it is possible to prevent the engine 1 from rotating with power output from the motor generator 21. For this reason, it is possible to prevent power transmitted from the motor generator 21 to the wheels 2 from being used to rotate the engine 1, and to reduce power loss during the EV traveling.

The switching clutch C is brought into the second engagement state during the free traveling, whereby, even in a state in which the engine 1 is stopped, the mechanical oil pump 22 is driven by external force (rotation force) input from the wheels 2 to the axles 8. With this, even in a traveling state in which the engine 1 is stopped, it is possible to supply lubricant oil from the mechanical oil pump 22 to a part to be lubricated of the drive device 100.

During the MG regeneration, external force (rotation force) that is input from the wheels 2 to the axles 8 while the vehicle Ve is traveling is transmitted to the auxiliary device 20 through the second power transmission device 42. In this case, since the clutch K0 is released, it is possible to prevent the engine 1 from rotating with external force (reversely input power) input from the wheels 2 to the power transmission mechanism 10. For this reason, it is possible to prevent power transmitted from the wheels 2 to the auxiliary device 20 from being used to rotate the engine 1, and to reduce energy loss during the MG regeneration.

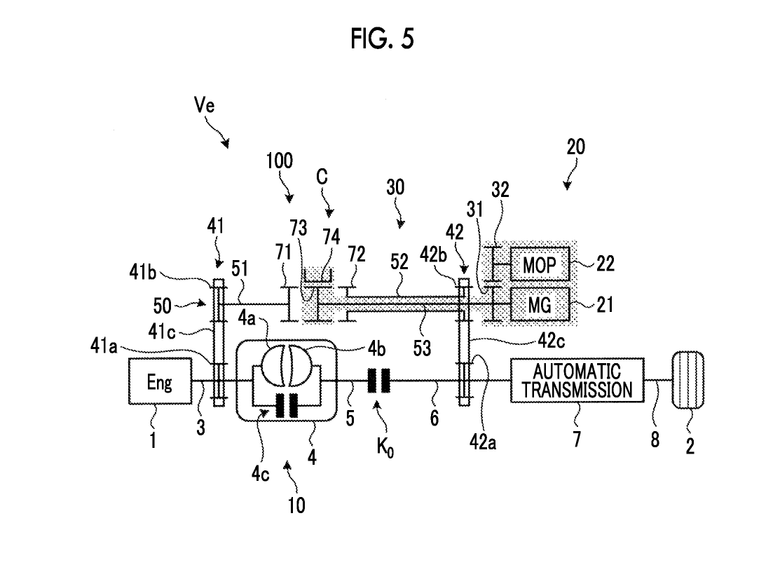

FIG. 5 is a diagram illustrating a state in which the auxiliary device 20 is not connected to the engine shaft 3 and the axles 8. As shown in FIG. 5, in a case where the switching clutch C is in the neutral state, the auxiliary device 20 is disconnected from the engine 1 and the wheels 2. Even in the neutral state, since the motor generator 21 and the mechanical oil pump 22 are connected such that power transmission is possible, it is possible to drive the mechanical oil pump 22 with the motor generator 21. For example, as a vehicle state in which the switching clutch C is brought into the neutral state, a state (eighth vehicle state: during stop-start) in which fuel supply to the engine 1 and ignition are stopped in a case where the vehicle Ve is temporarily stopped due to waiting for a traffic signal or the like, or a state (ninth vehicle state: during traveling at extremely low vehicle speed) in which the vehicle Ve is traveling at an extremely low vehicle speed in a state in which fuel supply to the engine 1 and ignition are stopped is exemplified. The extremely low vehicle speed is, for example, several km/h. A dot-patterned part shown in FIG. 5 represents a part that rotates in synchronization with the third shaft 53 in a case where the third shaft 53 rotates in the neutral state.

As described above, with the drive device 100, it is possible to switch the connection destination of the auxiliary device 20 between the engine 1 and the wheels 2 with the single switching clutch C. That is, since the switching clutch C may be solely operated, control for switching the connection destination of the auxiliary device 20 is simplified compared to a configuration in which two clutches need to be operated as in the configuration of the related art. In a case of executing control for switching the connection destination of the auxiliary device 20 between the engine 1 side and the wheels 2 side, since a clutch to be a control target is solely the switching clutch C, the switching control of the connection destination is simplified.

The switching clutch C is a single clutch, and can realize three states including the first engagement state in which the auxiliary device 20 is connected to the engine 1, the second engagement state in which the auxiliary device 20 is connected to wheels 2, and the neutral state. In the first engagement state, the auxiliary device 20 and the wheels 2 are shut off such that power transmission is impossible, and in the second engagement state, the auxiliary device 20 and the engine 1 are shut off such that power transmission is impossible. That is, since the switching clutch C in the engagement state can be connected to solely one of the engine shaft 3 and the axles 8, the engine shaft 3 and the axles 8 are not connected through the layshaft 50 such that power transmission is possible. With this, the switching control of the connection destination is simplified.

Since the single switching clutch C is provided instead of the two switching clutches in the configuration of the related art, mountability of the vehicle Ve is improved. In addition, since a single actuator of the switching clutch C, that is, a single actuator for switching the connection destination of the auxiliary device 20 may be provided, it is possible to suppress an increase in size of the drive device 100. For example, in a case where the actuator of the switching clutch C is a hydraulic actuator, it is possible to simplify a hydraulic circuit compared to the configuration of the related art in which the two switching clutches are needed.

The present disclosure is not limited to the above-described embodiment, and can be appropriately changed without departing from the object of the present disclosure.

For example, the switching clutch C is not limited to a hydraulic type, and may be constituted of an electromagnetic clutch. An electromagnetic switching clutch C has an electromagnetic actuator that moves the sleeve 74 in the axial direction. When the electromagnetic actuator is turned off, the sleeve 74 is at a meshing position (initial position) with the first engagement element 71. That is, even in a case where the switching clutch C is of an electromagnetic type, the sleeve 74 is returned to the meshing position with the first engagement element 71 by energizing force of a return spring. Then, in a state in which the electromagnetic actuator is turned on, the sleeve 74 moves from the first engagement element 71 side toward the second engagement element 72 side in the axial direction.

The meshing type switching clutch C is not limited to an externally fitting sleeve type configured such that the spline teeth formed on the inner circumferential surface of the sleeve 74 mesh. For example, the meshing type switching clutch C can constitute a meshing type switching clutch C configured such that dog teeth (teeth protruding in the axial direction) provided on the first engagement element 71 mesh with dog teeth (engine side dog teeth) on a first side of the clutch hub 73. The switching clutch C in this case can be configured such that the dog teeth provided on the second engagement element 72 mesh with dog teeth (wheels side dog teeth) on a second side of the clutch hub 73. The switching clutch C is configured to be switchable with the sleeve 74 moving in the axial direction between a state (first engagement state) in which the dog teeth of the first engagement element 71 mesh with the dog teeth of the clutch hub 73 and the dog teeth of the second engagement element 72 do not mesh with the dog teeth of the clutch hub 73 and a state (second engagement state) in which the dog teeth of the second engagement element 72 mesh with the dog teeth of the clutch hub 73 and the dog teeth of the first engagement element 71 do not mesh with the dog teeth of the clutch hub 73.

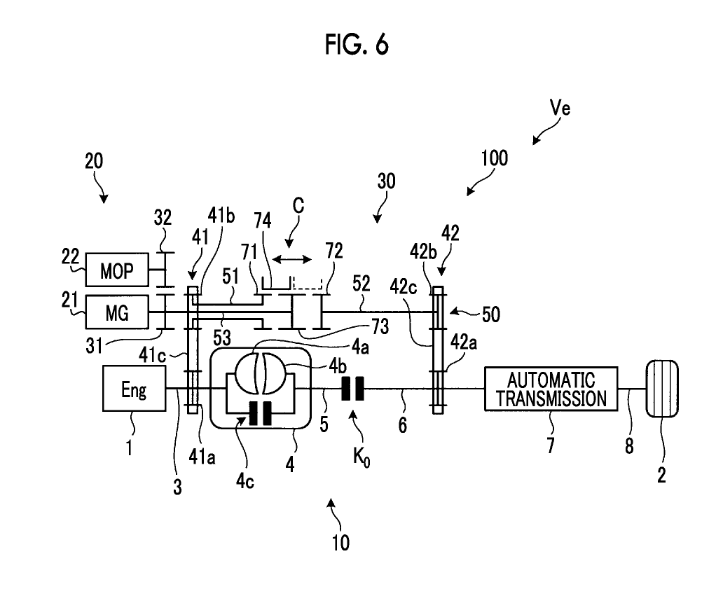

The auxiliary device drive mechanism 30 can be configured such that at least one shaft of the first shaft 51 and the second shaft 52 is formed of a hollow shaft and the third shaft 53 is disposed to pass through the inside of the hollow shaft. FIG. 6 is a schematic view showing a case where the first shaft 51 is formed of a hollow shaft. In the auxiliary device drive mechanism 30 shown in FIG. 6, the third shaft 53 is disposed to pass through the inside of the first shaft 51 that is a hollow shaft. In this example, the second shaft 52 is not a hollow shaft. Then, the clutch hub 73 is provided in a first protrusion portion of the third shaft 53 that protrudes from a first end portion side of the first shaft 51, and the drive gear 31 is provided in a second protrusion portion of the third shaft 53 that protrudes from a second end portion side of the first shaft 51.

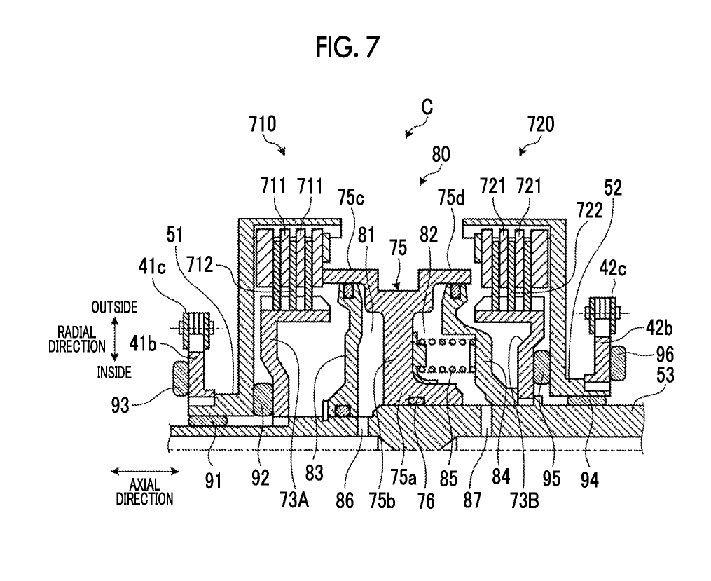

The switching clutch C is not limited to a meshing type, and may be a frictional type. In a case where the switching clutch C is a frictional clutch, a first frictional engagement element provided to rotate integrally with the clutch hub 73 is frictionally engaged with the first engagement element 71, and a second frictional engagement element provided to rotate integrally with the clutch hub 73 is frictionally engaged with the second engagement element 72. For example, in a case where the frictional switching clutch C has a hydraulic actuator, the frictional switching clutch C is configured to be switchable among the first engagement state, the second engagement state, and the neutral state with the single hydraulic actuator. An example of the frictional switching clutch C is shown in FIG. 7. In the description of the frictional switching clutch C, description of the same configurations as those in the above-described embodiment will not be repeated, and the same reference numerals will be used.

As shown in FIG. 7, the frictional switching clutch C is a multi-plate clutch, and includes a first frictional engagement part 710 that selectively connects the first shaft 51 and the third shaft 53 such that power transmission is possible, a second frictional engagement part 720 that selectively connects the second shaft 52 and the third shaft 53 such that power transmission is possible, and a hydraulic actuator 80 that operates one piston 75. The piston 75 is an annular member disposed between the first frictional engagement part 710 and the second frictional engagement part 720 in the axial direction, and is configured to be movable on the third shaft 53 in the axial direction.

Specifically, the piston 75 has a boss part 75a that is attached to the outer circumferential portion of the third shaft 53, a flange part 75b that extends radially outward from the boss part 75a, a first pressing part 75c that protrudes to a first side of the axial direction from the flange part 75b, and a second pressing part 75d that protrudes to a second side of the axial direction from the flange part 75b. The first pressing part 75c is a part that presses the first frictional engagement part 710. The second pressing part 75d is a part that presses the second frictional engagement part 720. A seal material 76 seals between the inner circumferential surface of the boss part 75a and the outer circumferential surface of the third shaft 53. Then, the piston 75 is pressed to the first frictional engagement part 710 side by energizing force of a return spring 85 described below.

In the first frictional engagement part 710, a first engagement element 711 that is a friction plate rotating integrally with the first shaft 51 is frictionally engaged with a third engagement element 712 that is a friction plate rotating integrally with the third shaft 53. The third engagement element 712 is attached to the outer circumferential portion of a first clutch hub 73A. The inner circumferential portion of the first clutch hub 73A is spline-fitted to the third shaft 53. In the second frictional engagement part 720, a second engagement element 721 that is a friction plate rotating integrally with the second shaft 52 is frictionally engaged with a fourth engagement element 722 that is a friction plate rotating integrally with the third shaft 53. The fourth engagement element 722 is attached to the outer circumferential portion of a second clutch hub 73B. The inner circumferential portion of the second clutch hub 73B is spline-fitted to the third shaft 53.

The hydraulic actuator 80 has the piston 75, a first hydraulic chamber 81, a second hydraulic chamber 82, a first cylinder 83 that is an annular plate member, a second cylinder 84 that is an annular plate member, and the return spring 85 that is provided inside the second hydraulic chamber 82.

The first cylinder 83 and the second cylinder 84 are disposed on opposite sides in the axial direction with the flange part 75b of the piston 75 sandwiched therebetween. The first cylinder 83 is disposed radially inside the first pressing part 75c of the piston 75. The second cylinder 84 is disposed radially inside the second pressing part 75d of the piston 75. Then, the inner circumferential portion of the first cylinder 83 is attached to the outer circumferential portion of the third shaft 53 in a sealed state. The outer circumferential portion of the first cylinder 83 is attached to the inner circumferential portion of the first pressing part 75c in a sealed state. The inner circumferential portion of the second cylinder 84 is attached to the outer circumferential portion of the third shaft 53 in a sealed state. The outer circumferential portion of the second cylinder 84 is attached to the inner circumferential portion of the second pressing part 75d in a sealed state. The first cylinder 83 and the second cylinder 84 are configured to be unmovable in the axial direction.

The first hydraulic chamber 81 is partitioned by the piston 75 and the first cylinder 83, and is supplied with oil ejected from the mechanical oil pump 22 through an oil passage 86 for clutch control. The second hydraulic chamber 82 is partitioned by the piston 75 and the second cylinder 84, and is supplied with oil ejected from the mechanical oil pump 22 through an oil passage 87 for cancel. The oil passages 86, 87 are provided on the third shaft 53.

The return spring 85 is disposed in a contracted state so as to be sandwiched between the second cylinder 84 and the piston 75 from both sides in the axial direction. In a case where the mechanical oil pump 22 is stopped, since oil is not supplied to the first hydraulic chamber 81, the piston 75 is brought into a state (first engagement state) of being stopped at a position pressing the first frictional engagement part 710 is brought by the energizing force of the return spring 85. Then, in a case where the mechanical oil pump 22 is driven to supply oil to the first hydraulic chamber 81, the piston 75 moves toward the second frictional engagement part 720 side in the axial direction against the energizing force of the return spring 85 and is brought into a state (second engagement state) of pressing the second frictional engagement part 720. Oil is supplied to the second hydraulic chamber 82 to balance the total of hydraulic pressure of the second hydraulic chamber 82 and the energizing force of the return spring 85 with hydraulic pressure of the first hydraulic chamber 81, whereby the piston 75 is brought into a state (neutral state) of being stopped at a position separated from both of the first frictional engagement part 710 and the second frictional engagement part 720.

In the example shown in FIG. 7, the first shaft 51 and the second shaft 52 are formed of hollow shafts. The first shaft 51 is relatively rotatable with respect to the third shaft 53 through a shaft bearing 91, and is relatively rotatable with respect to the first clutch hub 73A through a shaft bearing 92. The second gear 41b that is spline-fitted to the first shaft 51 is supported rotatably with respect to a fixed portion (not shown) by a shaft bearing 93. The second shaft 52 is relatively rotatable with respect to the third shaft 53 through a shaft bearing 94, and is relatively rotatable with respect to the second clutch hub 73B through a shaft bearing 95. The second gear 42b that is spline-fitted to the second shaft 52 is supported rotatably with respect to a fixed portion (not shown) by a shaft bearing 96.

What is claimed is:

1. A drive device for a vehicle comprising:
a power transmission mechanism configured to transmit power output from an output shaft of an engine mounted in the vehicle to wheels of the vehicle;
an auxiliary device;
a layshaft disposed on a different axis from the output shaft, the layshaft including a first shaft, a second shaft, and a third shaft, the first shaft being coupled to the output shaft so as to transmit power, the second shaft being coupled to axles attached to the wheels so as to transmit power, the third shaft being configured to relatively rotate with respect to the first shaft and the second shaft, and the third shaft being coupled to the auxiliary device so as to transmit power; and
a switching clutch configured to selectively connect one of the first shaft and the second shaft to the third shaft so as to transmit power.

2. The drive device according to claim 1, wherein:
the first shaft, the second shaft, the third shaft, and the switching clutch are disposed on a same axis;
one of the first shaft and the second shaft is a hollow shaft; and
the third shaft is disposed to pass through an inside of the hollow shaft.

3. The drive device according to claim 1, wherein:
the auxiliary device includes a mechanical oil pump configured to be driven with rotation of the third shaft and supply lubricant oil to a part to be lubricated of the vehicle;
the switching clutch is a meshing type clutch; and
the switching clutch is configured to connect the first shaft and the third shaft such that power transmission is possible when an ignition switch of the vehicle is turned off, and shut off between the second shaft and the third shaft such that power transmission is impossible.

4. The drive device according to claim 1, wherein:
the power transmission mechanism includes a disconnection clutch configured to selectively disconnect the engine from the wheels during traveling;
the auxiliary device includes a mechanical oil pump configured to be driven with rotation of the third shaft and supply lubricant oil to a part to be lubricated of the vehicle;
the switching clutch is a meshing type clutch; and
the switching clutch is configured to connect the second shaft and the third shaft such that power transmission is possible in a vehicle state in which fuel supply to the engine and ignition are stopped during traveling of the vehicle and the disconnection clutch is released to disconnect the engine from the wheels, and shut off between the first shaft and the third shaft such that power transmission is impossible.

5. The drive device according to claim 4, wherein:
the auxiliary device includes a motor generator configured to be coupled to the mechanical oil pump such that power transmission is possible and operate as a power generator and an electric motor; and
the motor generator is configured to operate as an electric motor that outputs power transmitted to the wheels or operate as a power generator with rotation force input from the wheels to the axles when the meshing type clutch connects the second shaft and the third shaft such that power transmission is possible in a vehicle state in which fuel supply to the engine and ignition are stopped during traveling of the vehicle and the disconnection clutch is released to disconnect the engine from the wheels.

6. The drive device according to claim 1, wherein:
the switching clutch is configured to be switched to a neutral state in which the first shaft and the second shaft are shut off from the third shaft such that power transmission is impossible;
the auxiliary device includes a mechanical oil pump configured to be driven with rotation of the third shaft and supply lubricant oil to a part to be lubricated of the vehicle;
the auxiliary device includes a motor generator configured to be coupled to the mechanical oil pump such that power transmission is possible and operate as an electric motor and a power generator; and
the motor generator is configured to operate as an electric motor that drives the mechanical oil pump when the switching clutch is in the neutral state.
